(19) United States
(12) Patent Application Publication
(10) Pub. No.: US 2006/0201337 A1
(43) Pub. Date: Sep. 14, 2006

(54) Cupcake Shot Glass Method and System

(76) Inventor: Deborah K. Currier, Groveland, FL (US)

Correspondence Address: LAW OFFICE OF MICHAEL A. BLAKE, 112 BROAD STREET, MILFORD, CT, 06460, US

(21) Appl. No.: 10/905,149

(22) Filed: Dec. 17, 2004

(51) Int. Cl. A47J 43/18

(52) U.S. Cl. 99/426

(57) ABSTRACT

A cupcake shot glass system comprising: a shot glass; a connector affixed to a bottom surface of the shot glass; and a bake cup liner affixable to the connector. A method of individualizing a cup cake shot glass system. The method comprises: choosing a size; choosing a theme; choosing a flavor; choosing a topping; and choosing a liquid medium. Also, a method also relates to a method of individualizing a cup cake shot glass system comprising: choosing a theme and size for the cupcake shot glass system; choosing a syrup; and choosing sprinkles, whipped cream and club soda.

### TECHNICAL FIELD

This method and system relates generally to novelty drinks, and more particularly to a method and system for providing a novelty drink with a cupcake appearance.

### BACKGROUND

Decorative beverages systems are currently experiencing popularity among consumers. One such decorative beverage system is a cupcake shot glass system. The cupcake shot glass presents a drink in a shot glass that looks similar to an actual cupcake. Consumers have used these cupcake shot glass systems for weddings; holidays such as Christmas, New Years, Valentine's Day, Halloween, birthdays, bachelor and bachelorette parties, graduation, and while watching or attending sporting events.

Current cupcake shot glass systems have some drawbacks. The shot glass is made of glass, and may break during shipping, transportation or use. Also, when multiple shot glasses are being shipped, or otherwise transported, the cumulative weight of the glass shot glasses increase shipping costs. Also, current cupcake shot glass systems use an adhesive or mounting square that are first installed on a bake cup liner, then the bake cup liner with the adhesive or mounting square is attached to a shot glass. Installing the adhesive or mounting square on a bake cup liner is labor intensive and increases the cost of current cupcake shot glass systems. Additionally, the adhesive or mounting square may have difficulty staying attached to the bake cup liner material over prolonged periods of time due to the relatively porous material comprising the bake cup liner. Current cupcake shot glass systems use shot glasses that are about 2.5 ounces. If alcohol is used in the cupcake shot glass, more than 1.5 ounces may be placed into the shot glass, which may run afoul of local liquor regulations which require alcoholic beverages sold or consumed in public to contain no more than 1.5 ounces of liquor.

Accordingly there is a need for a cupcake shot glass system that overcomes these and other disadvantages.

### SUMMARY

The disclosed apparatus relates to a cupcake shot glass system comprising: a shot glass; a connector affixed to a bottom surface of the shot glass; and a bake cup liner affixable to the connector.

The disclosed method relates to a method of individualizing a cup cake shot glass system. The method comprises: choosing a theme; choosing a size; choosing a flavor; choosing a topping; and choosing a liquid medium.

The disclosed method also relates to a method of individualizing a cup cake shot glass system comprising: choosing a theme and size for the cupcake shot glass system; choosing a syrup; and choosing sprinkles, whipped cream and club soda.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front view of one embodiment of a disclosed cupcake shot glass novelty beverage;

FIG. 2 is a front view of a shot glass with a connector on its bottom surface;

FIG. 3 is a flow chart illustrating one embodiment of a disclosed method; and

FIG. 4 is a flow chart illustrating another method of a disclosed method.

### DETAILED DESCRIPTION

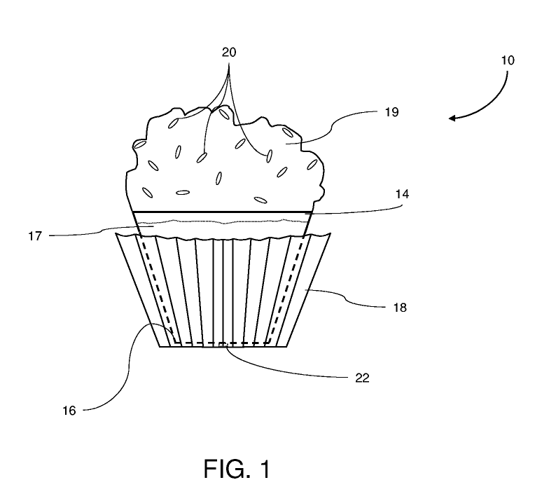

FIG. 1 is a front view of one embodiment of the cupcake shot glass system 10. The cupcake shot glass system comprises a shot glass 14 located within a bake cup liner 18. A connector 22 couples the bake cup liner 18 to a bottom surface 16 of the shot glass 14. The shot glass may be made from any number of materials that are lighter than glass, but less prone to breakage than glass. Such materials include, but are not limited to: plastics; clear acrylic; Lexan; polycarbonate; acrylic; plexiglass; and PETG. The connector 22 should be affixable to the shot glass 14 and able to provide a surface for the bake cup liner 18 to adhere too. A potable liquid 17 may be placed in the shot glass 14. The potable liquid may be any of numerous delicious drinks, including, but not limited to, individually and in combination with one or more: flavored syrups, alcohol, liquor, liqueur, club soda, water, flavored soda, fruit juice, and vegetable juice. A whipped topping 19 may be placed on the liquid in the shot glass 14. The topping 19 may be any of a number of delicious edible toppings, including, but not limited to: non-dairy whipped topping, whipped cream, and pudding. The whipped topping 19 may be topped with edible bits 20. The edible bits 20 may be any of a number of items, including, but not limited to: sprinkles, candied sprinkles, sugar sprinkles, nuts, coconut shavings, candies. Thus, when completed, the cup cake shot glass system 10 provides a fun drink that looks like a cupcake.

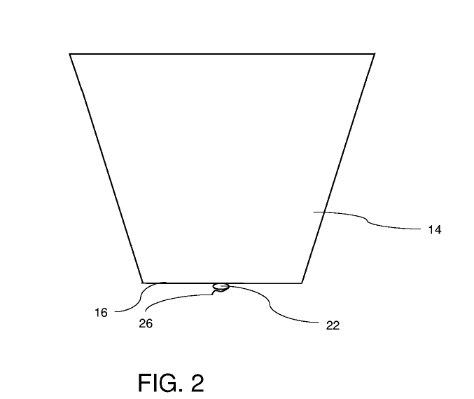

Referring now to FIG. 2, a front view of the shot glass 14 with the connector 22 affixed to the bottom surface 16 of the shot glass 14 is shown. The connector may be, but not limited to: two sided tape, mounting square, glue dot, tack and stick type reusable adhesive, glue, rubber cement, and epoxy. The connector 22 may have some sort of removable material 26, such as a film, which when removed, allows one to affix the bake cup liner 18 to the shot glass 14. Additionally, the shot glass 14 may be about 2 ounces in size. In another embodiment, the shot glass 14 may be about 5 ounces in size. The 2 ounce version helps insure that no more than 1.5 ounces of liquor is served in one shot glass 14. The 5 ounce version provides for a version of the cupcake shot glass system that more readily allows for sipping of the drink, instead of drinking in one swallow, like shot drinks are often consumed.

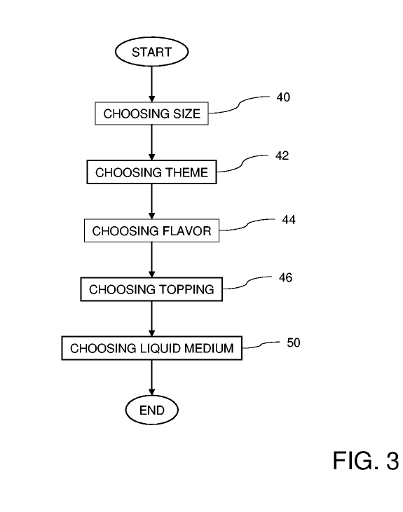

FIG. 3 illustrates one disclosed method of creating an individualized cupcake shot glass system. Act 40 is choosing a size for the cupcake shot glass system. The sizes include, but are not limited to, a shot glass size of about 2 ounces, and a shot glass size of about 5 ounces. Act 42 is choosing a theme for the cupcake shot glass system. The themes include, but are not limited to: autumn pumpkins, holiday holly, snowflake, snowman, new year's celebration, Mardi Gras, sweetheart, shamrock, all occasion, floral, summertime, bridal shower, ladies' night, congratulations, golden, silver, wedding, anniversary, graduation, rubber ducky, patriotic stars, patriotic, wedding doves, smiley face, football, baseball, soccer, pastel, and Halloween. Act 44 is choosing a flavor for the cupcake shot glass system. Choosing a flavor may comprise the act of choosing a particular type or types of syrup, liquor, or liqueur to flavor the cupcake shot glass drink. The syrups to choose from include, but are not limited to: vanilla flavored, cranberry flavored, watermelon flavored, cherry flavored, strawberry flavored, Granny Smith apple flavored, per bottle or by a plurality of bottles, and variety pack. Act 46 is choosing a topping for the cupcake shot glass system. Choosing a topping may comprise the acts of choosing sprinkles and choosing a whipped cream. The types of sprinkles to choose from may include, but are not limited to: nonpareils, rainbow colored, red, green, white, chocolate, red sugar, orange sugar, black sugar, dark green sugar, patriotic mix (red/white/blue), and blue sugar. The types of whipped cream to choose from may include, but are not limited to: vanilla whipped topping, strawberry whipped topping, chocolate whipped topping, mocha whipped topping. Additionally, the user may use whipped cream from a Wilton® dessert whipper pro device. Act 50 is choosing a liquid medium for the cupcake shot glass system. Act 50 may comprise choosing a type of water, choosing a type of alcoholic liquid, and choosing a type of club soda. The types of club soda to choose from include, but are not limited to: one liter bottle of club soda and one 10 oz. bottle of club soda.

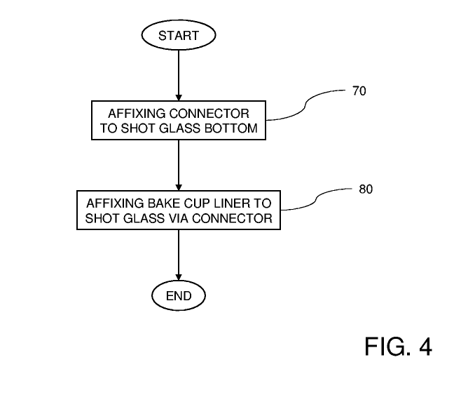

FIG. 4 illustrates another disclosed method. Act 70 is affixing a connector to a shot glass bottom. Act 80 is affixing a bake cup liner to the shot glass bottom via the connector. The connector may be, but not limited to, one of the following: two sided tape, mounting square, glue dot, tack and stick type reusable adhesive, glue, rubber cement, and epoxy.

The disclosed cupcake shot glass method and system provides less labor intensive means of affixing a bake cup liner to a shot glass bottom. Additionally, the shot glass should be able to remain affixed to the connector for a longer period of time than a connector would remain affixed to a paper bake cup liner. Additionally, the about 2 ounce sized shot glass allows one to more easily keep the amount of alcohol in a cupcake shot to no more than 1.5 ounces. The about 5 ounce shot glass allows one to more readily sip at the cupcake shot glass drink. The method of choosing the theme, size, syrup, liquor, or liqueur, sprinkles, whipped cream and club soda gives much more variety to the consumer, as opposed to merely purchasing pre-packaged cupcake shot glass systems.

It should also be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. A cupcake shot glass system comprising:
a shot glass;
a connector affixed to a bottom surface of the shot glass; and
a bake cup liner affixable to the connector.

2. The cupcake shot glass system of claim 1, further comprising:
a liquid located in the shot glass; and
a whipped topping located on the liquid.

3. The cupcake shot glass system of claim 2, further comprising:
edible bits located on the whipped topping.

4. The cupcake shot glass system of claim 1, wherein the shot glass is a non-glass material.

5. The cupcake shot glass system of claim 1, wherein the non-glass material is selected from the group consisting of plastics; clear acrylic; Lexan; polycarbonate; acrylic; plexiglass; and PETG.

6. The cupcake shot glass system of claim 1, wherein the connector is a connector selected from the group consisting of two sided tape, mounting square, glue dot, tack and stick type reusable adhesive, glue, rubber cement, and epoxy.

7. The cupcake shot glass system of claim 1, wherein the size of the shot glass is about 2 ounces.

8. The cupcake shot glass system of claim 1, wherein the size of the shot glass is about 5 ounces.

9. A method of individualizing a cup cake shot glass system comprising:
choosing a size;
choosing a theme;
choosing a flavor;
choosing a topping; and
choosing a liquid medium.

10. The method of claim 9, wherein the theme is selected from the group consisting of autumn pumpkins, holiday holly, snowflake, snowman, new year's celebration, Mardi Gras, sweetheart, shamrock, all occasion, floral, summertime, bridal shower, ladies' night, congratulations, golden, silver, wedding, anniversary, graduation, rubber ducky, patriotic stars, patriotic, wedding doves, smiley face, football, baseball, soccer, pastel, and Halloween.

11. The method of claim 9, wherein the choosing a flavor comprises choosing a syrup.

12. The method of claim 11, wherein the syrup is selected from the group consisting of vanilla flavored, cranberry flavored, watermelon flavored, cherry flavored, strawberry flavored, Granny Smith apple flavored, per bottle or by a plurality of bottles, and variety pack.

13. The method of claim 9, wherein the size is selected from the group consisting of shot glasses of about 2 ounces and shot glasses of about 5 ounces.

14. The method of claim 9, wherein the choosing a topping comprises:
choosing sprinkles; and
choosing whipped cream.

15. The method of claim 14, wherein the sprinkles are selected from the group consisting of candied sprinkles, sugar sprinkles, nonpareils, rainbow colored, red, green, white, chocolate, red sugar, orange sugar, black sugar, dark green sugar, patriotic mix, and blue sugar.

16. The method of claim 15, wherein the whipped cream is selected from the group consisting of vanilla whipped topping, strawberry whipped topping, chocolate whipped topping, mocha whipped topping, and Wilton® dessert whipper pro.

17. The method of claim 9, wherein the choosing a liquid medium comprises choosing a club soda.

18. The method of claim 17, wherein the club soda is selected from the group consisting of one liter bottle of club soda and one 10 oz. bottle of club soda.

19. A method of individualizing a cup cake shot glass system comprising:
choosing a theme and size for the cupcake shot glass system;
choosing a syrup; and
choosing sprinkles, whipped cream and club soda.
